(19) United States
(12) Patent Application Publication
(10) Pub. No.: US 2003/0111978 A1
(43) Pub. Date: Jun. 19, 2003

(54) Electric wire reel for a mobile phone travel charger

(76) Inventor: Jung-Hwa Wang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/021,242

(22) Filed: Dec. 19, 2001

(51) Int. Cl. H02J 7/00

(52) U.S. Cl. 320/114

(57) ABSTRACT

An electric wire reel for a mobile phone travel charger comprises a body, a plug unit, a reel, a round plate, an electric wire, a contacting plate, and an electric circuitry therein. The plug unit is secured at one side of the body with one end extending outwardly and the other end being in contact with the electric circuitry. The reel comprises a post extending into the recess of the body. The post has a round plate with a pair of holes for the electrical wire to insert there through and in touch with metal wires of the contacting plate, which has extending a pair of feet in connection with the electric circuitry. When rotating the reel to release or collect electric wire, the electric wire is in constant connection with the electric power ends and conducted with the metal wires.

### BACKGROUND OF THE INVENTION

1. Field of the Invention

This invention relates to a charger reel, and more particular to a reel for a mobile phone travel charger.

2. Description of the Prior Art

Owing to the modem technology, mobile phones are so popular that travelers need no longer to run and look for a telephone, especially when traveling to a strange place. However, to carry the mobile phone requires a spare battery or a charger when staying away from home more than a day. Therefore, a battery charger becomes an important item for travelers.

A conventional mobile charger, as shown in FIG. 4, comprises a transformer with an electric wire extending from one side and an adapter connected to the other end of the wire, which is not convenient in carry. A later design was invented, which collapses the wire in a reel, which includes a wheel with a disc, a restoring element, and a stopper, wherein the disc is in parallel with a clutch, and spaced from each other for wiring purpose. The clutch has its outer surface in contact with electrical power. However, this design is for earpieces only without any other purpose.

In view of this and many other shortcomings, the inventor has invented the present invention, which solves all of the above shortcomings.

### SUMMARY OF THE INVENTION

It is the primary object of the present invention to provide an electric wire reel for a mobile phone travel charger, which is easy to operate and saves storage space.

It is another object of the present invention to provide an electric wire reel for a mobile phone travel charger, which is safe in use.

### BRIEF DESCRIPTION OF THE DRAWINGS

FIG. 1 is an exploded view of the present invention;

FIG. 2 is a side elevation view of the present invention, with partial sectioned;

FIG. 3 is a perspective view of the present invention, and

FIG. 4 is an exploded view of a prior art.

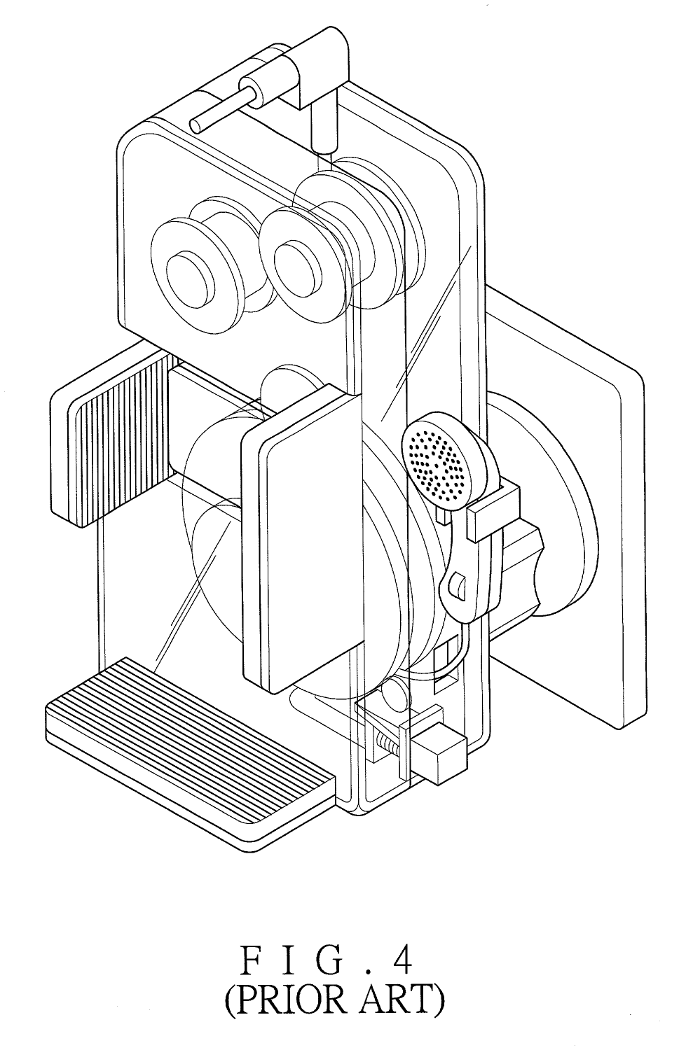

### DETAILED DESCRIPTION OF THE PREFERRED EMBODIMENT

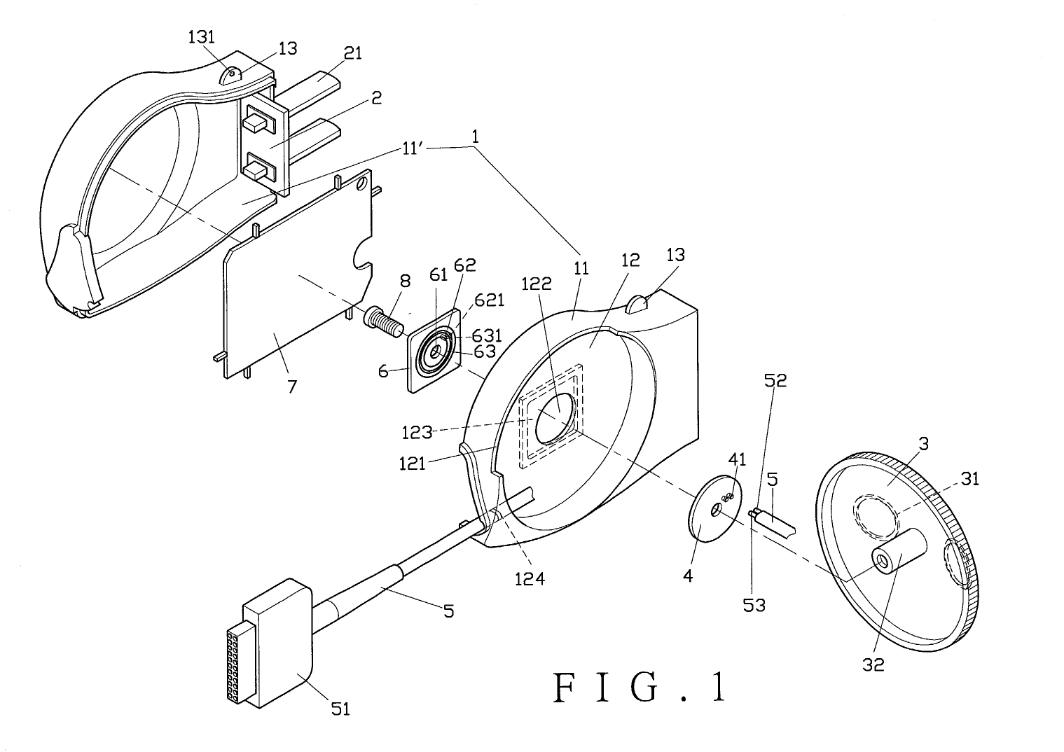

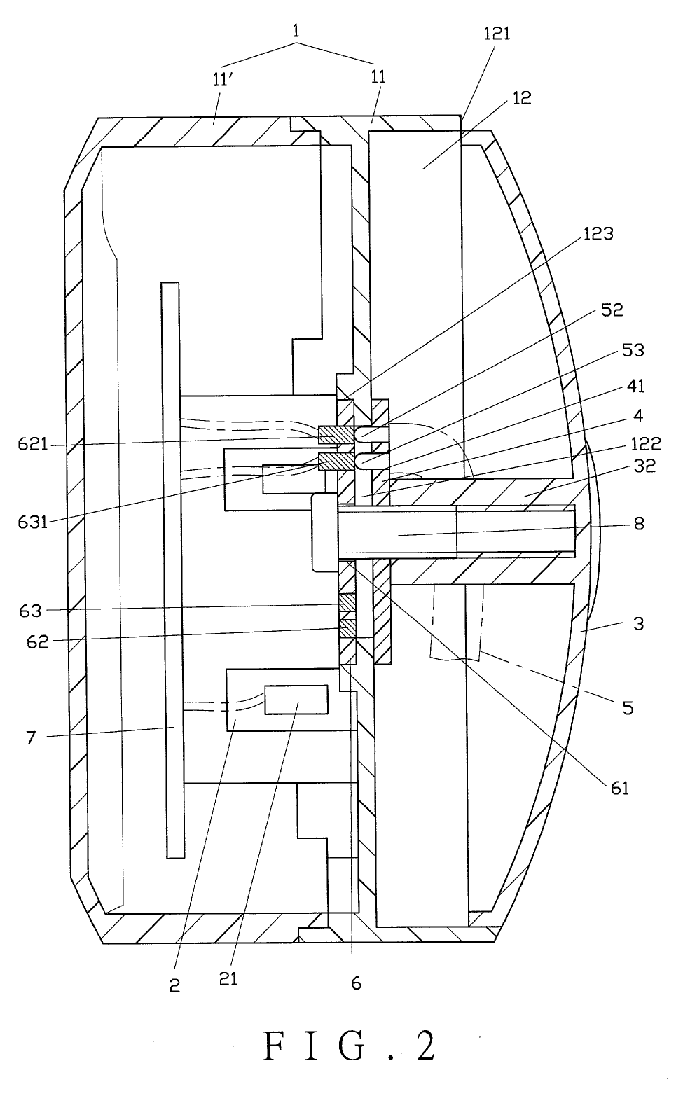

An electric wire reel for a mobile phone travel charger of the present invention, as shown in FIGS. 1 and 2, comprises a body 1, a plug unit 2, a reel 3, a round plate 4, an electric wire 5, a contacting plate 6, and an electric circuitry 7.

The body 1 is formed by a right body 11 and a left body 11′, which forms a hollow inside, the hollow inside of the right body 11 is a recess 12 to receive the electric wire 5 therein. The recess 12 has a notch 121 on the edge, a hole 122 on the center of the side wall with a confining trough 123, and a hole 124 for the electric wire 5 to extend there through. Both of the right body 11 and left body 11′ are formed to accept the plug unit 2 therein with feet 21 to extend outwardly from the body 1, and both the right body 11 and the left body 11′ have formed with a holder 13 having a protuberance 131 thereat.

The reel 3 has a reeling device 31 (it is a pair of two recesses in this instance to be operated by two fingers to rotate, the reel also comprises scales on the edge, which is easy to grasp and operate). The inner bottom portion of the reel 3 comprises a post 32, which secures with the round plate 4 and inserts through the hole 122. The round plate 4 may be integral to or fastened with the post 32 and comprises a pair of holes 41 for the electric wire 5 to insert there through.

The electric wire 5 has one end connected with an adaptor 51 and the other end of the wire 5 is inserted through the holes 41 of the round plate 4 and soldered to two electric power ends 52 and 53.

The contacting plate 6 comprises a hole 61 and a pair of metal wires 62 and 63 circling the hole 61 having extending a pair of feet 621 and 631 to be connected with the electric circuitry 7.

The electric circuitry 7 receives power supply from the plug unit 2 and output through the electric wire 5 and transformer to adjust its current and voltage to the limit and through the adapter 51 to a mobile phone.

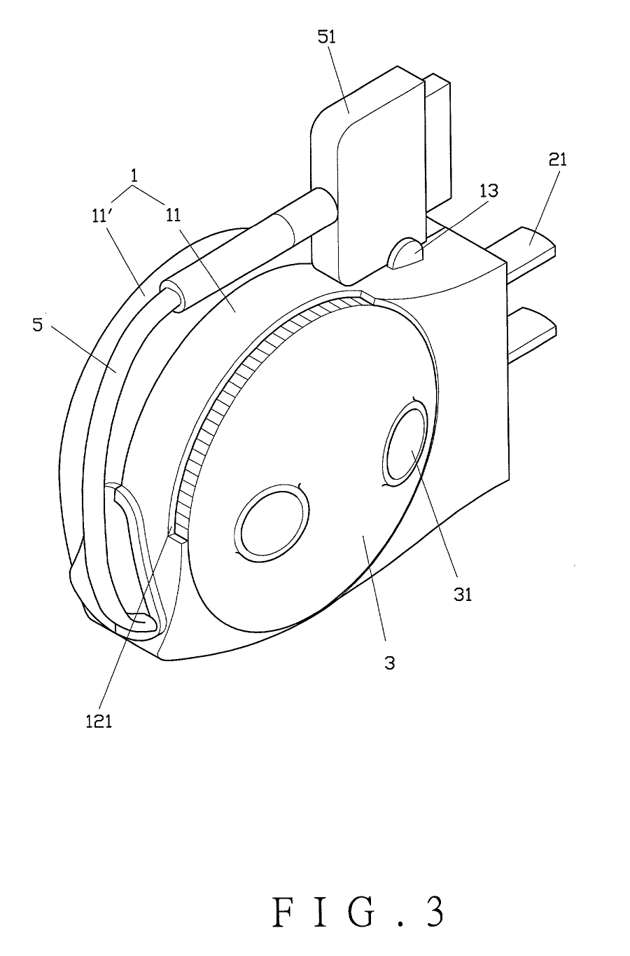

To assemble, as shown in FIGS. 2 and 3, the electric wire 5 is inserted through the hole 124 into the recess 12 and through the holes 41, and then is soldered to fix it thereat with a pair of electric power ends 52 and 53 extending outwardly and in touch with the metal wires 62 and 63 of the contacting plate 6. The contacting plate 6 is seated in the confining trough 123 and secured by a bolt 8 to insert through the center hole 61 and into a threaded hole of the post 32 to secure the contacting plate 6, the round plate 4 and the reel 3 at place, whereas the edge of the reel 3 exposes outward from the notch 121. Connect the feet 621 and 631 with the electric circuitry 7, and the plug unit 2 with the electric circuitry 7 with the two plugs 21 inserted into the body 1, and melt the right body 11 and the left body 11′ together, thus the reel for a mobile phone charger of the present invention is formed.

In practice, there are two ways of operating this invention, the first is to rotate the reeling device 31 of the reel 3, which links the post 32 and the round plate 4 to rotate, thus rotating the electric wire 5, this will cause the electric wire 5 to collapse or to release from the reel 3. Upon the electric wire 5 has reached to its limits, the adapter 51 may reach to the holder 13 and secured by the protuberance 131.

The second is to rotate the edge of the reel 3 exposing outward from the notch 121, which will also link the post 32 and the round plate 4 to rotate, thus rotating the electric wire 5, this will cause the electric wire 5 to collapse or to release from the reel 3. Upon the electric wire 5 has reached to its limits, the adapter 51 may reach to the holder 13 and secured by the protuberance 131.

The reel of the present invention may provide a restoring device between the reel with the body, which urges the reel at constant status, which keeps the electric wire 5 collapsed in the body 1, and a clutch is formed on the routing of the reel 3, which restrains the reel 3 to rotate freely.

I claim:

1. An electric wire reel for a mobile phone travel charge comprising a body, a plug unit, a reel, a round plate, and a contacting plate along with an electric circuitry and an electric wire, wherein said electric wire having connected with one end to an adapter, and said electric circuitry having an input end connected to said plug unit, whereas an output end of said electric circuitry being connected with a pair of metal wire, thus transform the current and voltage for a mobile phone charger, and being characterized in that,
said body comprising a hollow center to accommodate said electric circuitry, said plug unit, which has one end of its two feet exposed outwardly for plugging into a wall power unit, a right body of said body having a recess for accommodating said electric wire;
said reel comprising a post exposing from one inner side to be inserted into said recess of said right body, and a round plate with a pair of holes for electric power ends secured thereat;
said contacting plate comprising a pair of metal wires circling a center hole with a pair of feet extending outwardly to be contacted with said electric circuitry.
when rotating said reel to release or collect said electric wire, said electric wire is in constant connection with said electric power ends and conducted with said metal wires.

2. The electric wire reel for a mobile phone travel charge, as recited in claim 1, wherein said reel comprises a reeling device on top surface thereof.

3. The electric wire reel for a mobile phone travel charge, as recited in claim 1, wherein said body has a holder with a protuberance thereat.

4. The electric wire reel for a mobile phone travel charge, as recited in claim 1, wherein said recess of said right body comprises a notch, which allows portion edge of said reel to expose outwardly.
